(19) United States
(12) Patent Application Publication
(10) Pub. No.: US 2018/0085879 A1
(43) Pub. Date: Mar. 29, 2018

(54) MACHINE TOOL

(71) Applicant: SAMAG SAALFELDER WERKZEUGMASCHINEN GMBH, SAALFELD (DE)

(72) Inventor: DIRK NEUBERT, JENA (DE)

(21) Appl. No.: 15/563,721

(22) PCT Filed: Mar. 29, 2016
(86) PCT No.: PCT/IB2016/051767

§ 371 Date: Oct. 2, 2017

(30) Foreign Application Priority Data
Apr. 1, 2015 (DE) DE102015105043.9

(51) Int. Cl. B23Q 37/00; B23Q 1/62; B23Q 39/02

(52) U.S. Cl. CPC B23Q 37/007; B23Q 2039/006; B23Q 39/022; B23Q 1/626

(57) ABSTRACT

A machine tool includes at least first and second machining units being disposed adjacent each other in a first axial direction, movable independently of each other in second and third axial directions and disposed on a common machine bed. Stand units on both sides of the machining units are spaced apart from each other in the first axial direction. In order to provide high production flexibility and easy and cost-effective production and use, the machining units are guided by upper and lower guides and are movable independently of each other in the first, second and third axial direction, and/or the machine tool has a working width permitting at least one third machining unit to be provided and removed again in the first axial direction adjacent the first and/or the second machining unit. All of the machining units are structurally identical and/or have the same travel paths.

The present invention relates to a machine tool comprising at least one first and one second machining unit, being arranged adjacent to one another in a first axial direction and being movable independently from one another in a second and a third axial direction, which are arranged on a common machine bed, wherein spaced apart stand units are provided on both sides of the machining units in the first axial direction.

With known machine tools, the number of machining units or spindles, which the respective machine tool comprises, is already determined during the development of the machine tool and, for the entire life cycle of the machine tool, cannot be changed at all, or only at great effort and expense. Accordingly, machine tools, regardless of whether they are single-spindle or multi-spindle machine tools, are hardly flexible with regard to production conditions such as fluctuating product demand or a processing of workpieces with different component dimensions.

Thus, a user, when buying a machine tool, will have to determine from the very beginning whether he needs an expensive and space-consuming machine tool with a large number of spindles, for example due to expected high quantity demands, or whether he wants to acquire a more cost-efficient, space-saving machine tool with a smaller number of spindles and thus a lower output quantity. Accordingly, the manufacturers are often inflexible when it comes to changes in the production conditions or a change of the demand, and will potentially have to put up with losses in sales due to missing output quantities, or will have to put up with high costs for purchasing and operating, without achieving corresponding sales.

Single-spindle machine tools, whose spindle is movable in three axial directions, have been in the prior art for a long time. Furthermore, machining units with two working spindles being movable independently from one another in the z direction, fixed on a mount and a cross table, which is movable in x and y direction, are for example known from the document DE 20 2013 00 225 U1.

In order to achieve an increased accessibility to the workpiece by an increased flexibility of the spindles' movability with multi-spindle machine tools as well, it is possible for the spindles to be adjustable and movable independently from each other in two axial directions when they are arranged adjacent to each other, while the working table is adjustable in a further axial direction or that, if more than two spindles are provided adjacent to each other, the spindles are movable independently from each other in an axial direction and are connected to each other in another axial direction and thus are jointly movable in this further axial direction, while the working table hereby is also adjustable relative to the spindles in a third axial direction.

Thus, the document DE 195 03 482 C2 for example describes a gantry machine tool with two spaced apart vertical columns, on whose opposing inner sides vertical guides are provided, by means of which two spindle stocks, each provided on a slide, are vertically movable independently from each other. A horizontal movability of the spindle stocks is provided by horizontal guides provided on the slides. Accordingly, the spindle stocks are movable independently from each other in two movement directions. A third movement direction is achieved by moving a workpiece carrier arranged in front of the columns, movable transversely to the longitudinal direction of the spindle stocks.

In order to be able to process workpieces of different sizes, the document DE 10 2009 031 830 B3 presents a CNC gantry machine tool, whose processing section is extendable in x and y direction. For extending the processing section in x-direction, the processing section comprises mechanical interfaces as connecting elements by which further processing sections can be fixed on the first processing section. For varying the width of the at least one processing section in y direction, gantry guiding rails of the machine are pulled apart in y direction and a base of the gantry that is moved along a crossbar and then fixed in its new position. For this purpose a crossbar of the gantry protrudes beyond one side of the processing section, wherein the crossbar can also be extended by extension bars connectable thereto.

The document DE 977 459 contains a planing machine comprising a variable working width, wherein the planing machine comprises two stands being connected by a traverse, which are fastened to a base plate embedded in a foundation as well as a bed set upon the base plate by means of screws. For varying the working width, the base plate comprises several drillings for the screw fittings with the stand at different distances, according to different positions of the stand.

It is the object of the present invention to provide a machine tool with several machining units according to the above mentioned type, which comprises an increased production flexibility over known machine tools.

The object of the present invention is solved by a machine tool comprising at least one first and one second machining unit, being arranged adjacent to one another in a first axial direction and being movable independently from one another in a second and a third axial direction, which are arranged on a common machine bed, wherein spaced apart stand units are provided on both sides of the machining units in the first axial direction, wherein the machining units are guided through upper and lower guides and are movable independently from one another in the first, the second and the third axial direction and/or the machine tool comprises such a working width that at least a third machining unit is providable and removable again in the first axial direction adjacent to the first and/or the second machining unit, wherein all machining units are structurally identical and/or have the same travel paths.

The independent movability of at least two machining units in three differing axial directions according to the first embodiment of the machine tool according to the invention enables a flexible production of workpieces without a simultaneously movable working table. Thus, at least two workpieces can be processed at the same time with this machine tool according to the invention, wherein one machining unit each processes one workpiece and the machining units can thereby either perform the same processing steps or different processing steps at the same time. Thereby, the multi-axial processing in particular offers the advantage of being able to produce workpieces with a sophisticated geometry and of high complexity; error sources—which for example occur when re-clamping the workpieces—can be minimized, processing times can be reduced and a better surface quality of the workpieces can be achieved.

According to the first embodiment of the machine tool according to the invention, the machining units are guided on upper and lower guides, whose longitudinal sides are aligned in the first axial direction. In the process, the machining units can be moved through the upper and lower guides in direction of the first axial direction either independently from one another or coupled with each other.

Another aspect of the first embodiment of the present invention is that the machining units are guided on upper and lower guides and are thereby movable on them so that the machining units can be moved independently from each other, towards each other, away from each other or with each other. With this movability, the distance between the machining units can be easily varied and thus for example space can be made for placing at least one more machining unit between or adjacent to the at least two already existing machining units. Providing at least one more machining unit offers the advantage of being able to process a higher number of workpieces with the machine tool at the same time, whereby the output quantity of the machine tool can be increased without causing high additional expenses.

The upper and/or the lower guide can protrude beyond the width of the at least two machining units. Several upper as well as lower guides can also be provided on the machine tool. The lower and/or the upper guide can expediently be formed by one or at least two parallel continuous guiding rail(s), respectively. Alternatively it is possible for the upper and/or lower guide to be formed of at least two interconnected guiding rails, respectively. This way, for example, at least one corresponding guiding rail can be provided on every single machining unit, wherein the guiding rails provided on the at least two machining units, are provided spaced apart adjacent to each other on the machine tool.

In a special embodiment of the invention, the guides can also be extended by attaching at least one additional guiding element, by means of which the distance between at least two of the machining units can be extended, thus making it possible to provide a number of additional machining units between the at least two machining units, or to process larger workpieces in the machine tool.

The second embodiment of the present invention, in which the machine tool comprises such a working width that at least a third machining unit is providable and removable again in the first axial direction adjacent to the first and/or second machining unit, wherein all machining units are structurally identical and/or comprise the same travel paths, is applicable both independently and in connection with the first embodiment of the invention explained above.

According to the second embodiment, the machine tool is constructed in such a way that its working width is, while being fixed, defined in such a way that at least one additional machining unit of identical structure and/or with the same travel path is providable and/or removable again in a first axial direction. Such an embodiment of the machine tool can be provided with a particularly high mechanical stability.

The machining unit being additionally integrable in and also removable from the machine tool in the second embodiment of the machine tool according to the invention, comprises the same structure and the same travel paths as the at least two machining units already comprised by the machine tool. Preferably but not necessarily, this is also the case with the first embodiment of the machine tool according to the invention explained above. It is, however, also possible, for all machining units of the machine tool only to comprise the same travel paths or only the same structure.

Due to the variability of the distance between the machining units, there is a possibility to simply exchange the machining units of the machine tool or at least to replace it with another machining unit with a different travel path and/or a different structure. In that case, the number of machining units comprised by the machine tool can either remain constant, be reduced or increased. By changing, removing or adding at least one machining unit, workpieces of different dimensions, geometries and/or material characteristics can easily be processed with the machine tool according to the invention.

With the second embodiment of the machine tool according to the invention, it is not mandatory for the machining units to be guided above and below. The stand units of the machine tool formed as a gantry machine tool or the machining units can rather also be guided only through at least one lower guide, in order to be able to realize the movement of the machining units in all three movement directions. Hereby, the machining units can for example simply be provided on a bridge of the machine tool being situated between the stand units. Also, only at least one upper or only at least one lower guide can be provided on the machine tool for the machining units. This at least one upper or lower guide can for example be fixed on a bridge of the machine tool.

Both with the first and in the second embodiment of the present invention, the at least one additionally provided machining unit can for example be provided adjacent to at least one already existing machining unit in the machine tool without being mechanically connected to it, can, however, also be coupled with two or more of the already existing machining units. Furthermore, the at least one additional machining unit can be provided separately from the further machining units, for example on a bridge of the machine tool. For this, additional guides and/or mounting devices can for example be provided on such a bridge.

With the machine tool according to the invention, the movement of the machining units is preferably realized by means of a linear motor or a screw drive, wherein the form and arrangement of such a drive on the machine tool is variable and can be adjusted to the respective operating conditions. According to the invention, it is possible to provide a separate drive and/or a brake device on each guide. Furthermore, it is possible that several machining units of the machine tool are driven by one drive or that only individual axial directions of the machining units are drivable by one drive.

According to the invention, the at least two machining units are arranged on a common machine bed on two stand units spaced apart in the first axial direction. Thereby, at least two of the machining units each are preferably fixed on the sides of the stand units opposing each other in the first axial direction. The machining units are hereby provided in such way that they are movable in all three axial directions.

Guides proceeding in the second axial direction are hereby preferably provided on the stand units, for example on their sides opposing each other in the first axial direction. Particularly preferred, a slide is respectively provided on these guides, being movable along that guide, taking in the machining unit, which enables the at least one machining attached thereto to be movable along the second and third axial direction. The movement of the machining units along the first axial direction can for example be realized by moving the stand units.

In a particularly preferred embodiment of the machine tool according to the invention, the stand units are guided movable on the upper and lower guides. In a functional alignment of the machine tool, the upper and lower guides are hereby provided on the sides of the stand units facing upwards or downwards, so that the stand units are movable with each other, towards each other and against each other. Particularly preferred, the lower guides are hereby arranged on the common machine bed, whereas the upper guides are attached to an upper section of the machine tool, for example on a bridge of the machine tool. In another embodiment of the invention, the upper as well as the lower guides can also be attached to an upper or lower section of the stand unit's lateral faces.

By moving the stand units, process corrections can be carried out during or after a processing procedure, in order to be able to compensate for problems from preceding process sequences in subsequent processes. Furthermore, the working width between the stand units can, as described earlier, also be varied by moving the stand units, whereby the working space can be extended and at least one additional machining unit can easily be provided in the working area of the machine tool. According to the invention, this at least one additional machining unit can also be removed again and the processing section between the stand units can be reduced again. Changing the processing width between the stand units not only offers the advantage of being able to provide additional machining units; instead, workpieces with different dimensions can also be processed due to the changeability of the working width thus facilitated.

The movability of the stand units can be provided continuously or in sections, for example in predetermined steps.

According to the invention, the stand units as well as the machining units can comprise a common upper as well as a lower guide connecting the stand units; or can be connected or couplable with such a guide or each comprise separate upper and lower guides. It is also possible to provide several upper and/or lower guides on or for the stand units.

The movement of the stand units along the guides can for example be realized by means of a linear motor or a screw drive. The arrangement and form of the drive is thereby variably formable and therefore adjustable to the respective requirements and operating conditions of the machine tool.

Another preferable embodiment of the machine tool according to the invention provides that at least two of the machining units are coupled or couplable and decouplable in the first, the second and/or the third axial direction. Coupling the machining units offers the advantage that fewer driving units are necessary for moving several machining units, whereby the costs of the machining units can be minimized. Furthermore, the effort for programming and/or operating the machine tool can also be reduced by coupling the machining units.

Coupling the machining units is particularly appropriate where an independent movement of the machining units in at least one of the three different axial directions is not necessary. However, in order to be able to realize a movement of the machining units in all three axial directions if required, it is particularly recommendable to form or choose the coupling device used between the machining units in such a way that the machining units are decouplable again.

Depending on the production process, all movement directions of the respective machining units can be coupled or only one or two movement directions of the machining units can be coupled.

The number of coupled or couplable machining units can also be freely chosen. Thus, it is not mandatory for all machining units provided by the machine tool to be coupled. Rather, only two, three or another number of machining units can be coupled instead.

Moreover, it is possible to couple the movement of at least two of the machining units only with regard to individual and not all axial directions.

In another preferred embodiment of the machine tool, at least one of the machining units is swivable around the first and/or the second axial direction, so that a flexible four or five-axial processing of workpieces is possible. The machining units are hereby particularly preferably movable independently from each other, so that the machining units are swivable independently from each other in the first and/or the second axial direction. Hereby, the swivel movements of the individual machining units can be performed towards, against, with or in differing angular alingments of each other.

In an alternative embodiment of the machine tool according to the invention, at least two of the machining units are coupled or couplable and decouplable in their swivel movement around the first and/or the second axial direction. Just like the coupling of the linear movement of the machining units, the coupling of the swivel movements of the machining units offers the advantage that fewer drives are necessary and thus the costs can be reduced as well as the effort for programming and/or operating the machine tool can be reduced.

The coupling of the swivel movement of the individual machining units can be permanent; however, it is preferably detachable again, so that the swivel movement of the machining units can be realized independently from each other if required.

In another embodiment of the machine unit according to the invention, at least one control cabinet of the machine tool is arranged in the upper half of the machine tool. By such an arrangement, the area around the machine tool can be kept clear, whereby an improved accessibility to the components of the machine tool can be achieved, which in turn for example simplifies installation and/or maintenance works on the machine tool.

In a functional alignment or set-up of the machine tool, the half being situated above the half of the height of the machine tool, is to be considered as the upper half. Preferably, the control cabinet is attached to a surface, in this set-up being aligned towards the top, serving as a machine roof. This offers the advantage that the control cabinet can simply be placed on the machine without having to provide a complex mounting device for the control cabinet on the machine tool. However, the control cabinet can also be provided on at least one side wall of the machine tool, which offers the advantage that it is particularly easily accessible. Hereby, the control cabinet can either be attached on a side wall of the machine tool by means of a separate mounting device, or it can simply be screwed, riveted or welded with the machine tool. The arrangement of the control cabinet can be variably chosen, depending on the position and the set-up of the machine tool.

Preferred embodiments of the present invention, their structure, function and advantages are explained in more detail by the following figures, wherein

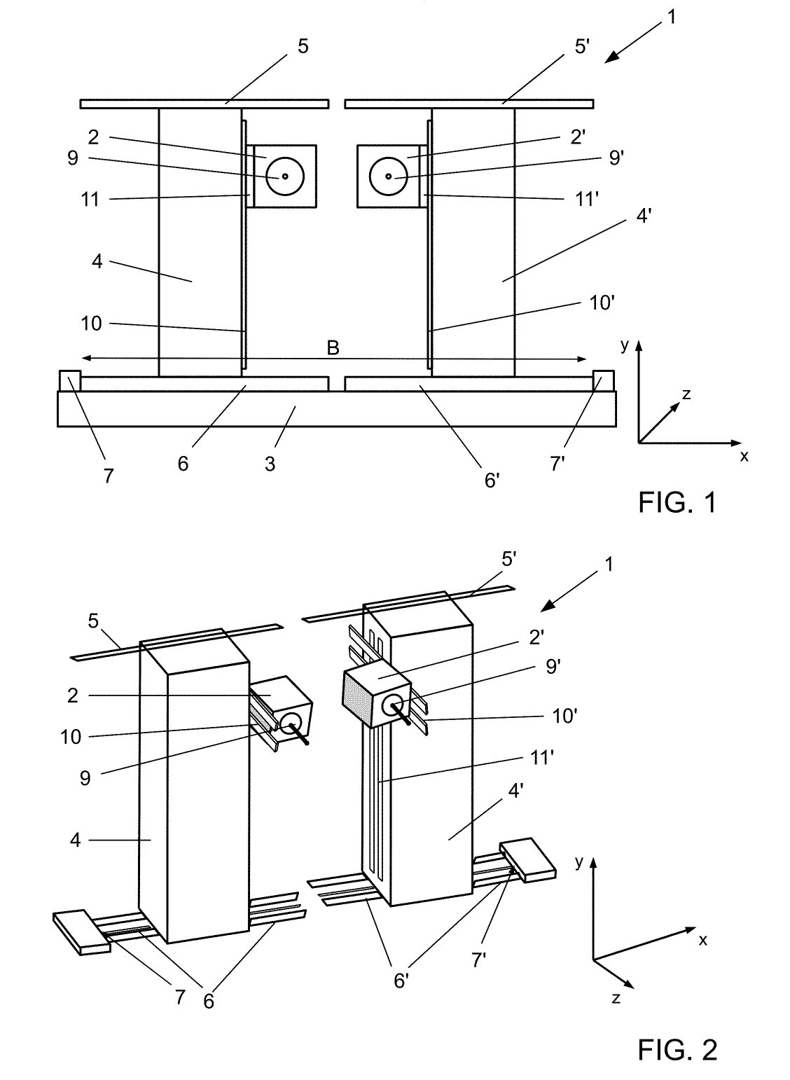

FIG. 1 schematically shows a possible embodiment of a machine tool according to the invention in a frontal view;

FIG. 2 schematically shows the machine tool from FIG. 1 in a perspective frontal view diagonally from above;

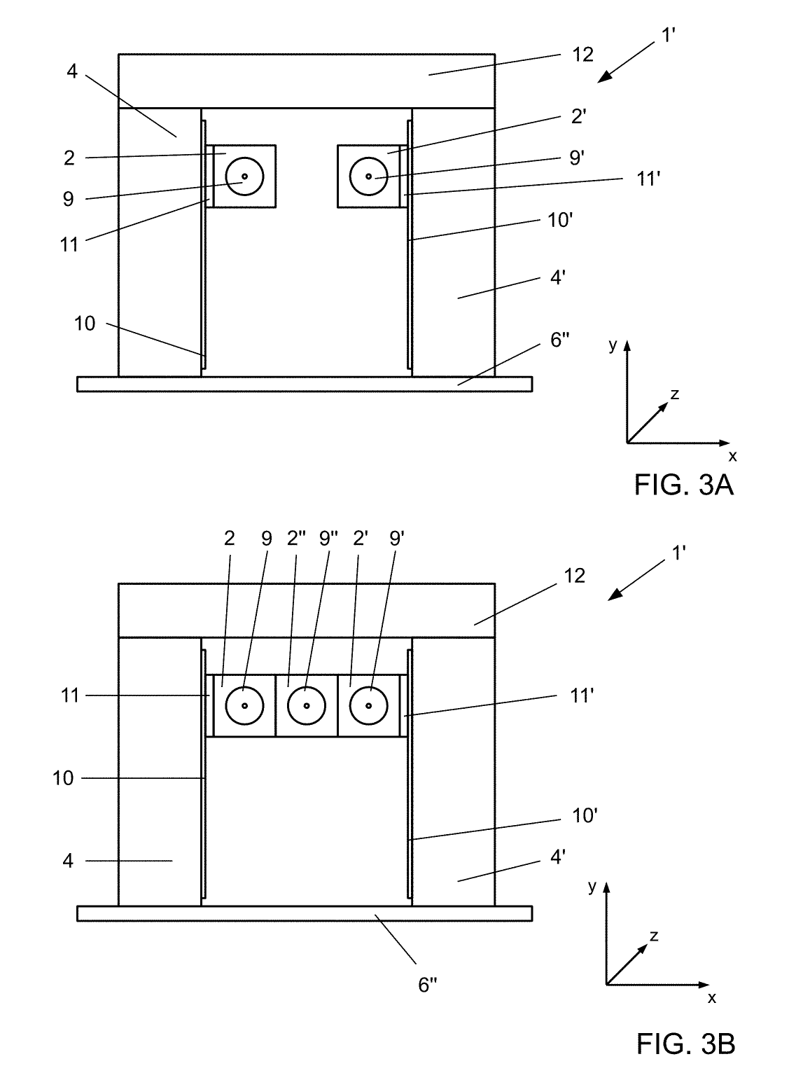

FIG. 3a schematically shows another embodiment of a machine tool according to the invention in a frontal view;

FIG. 3b schematically shows the machine tool shown in FIG. 3a with an additional machining unit in a frontal view; and

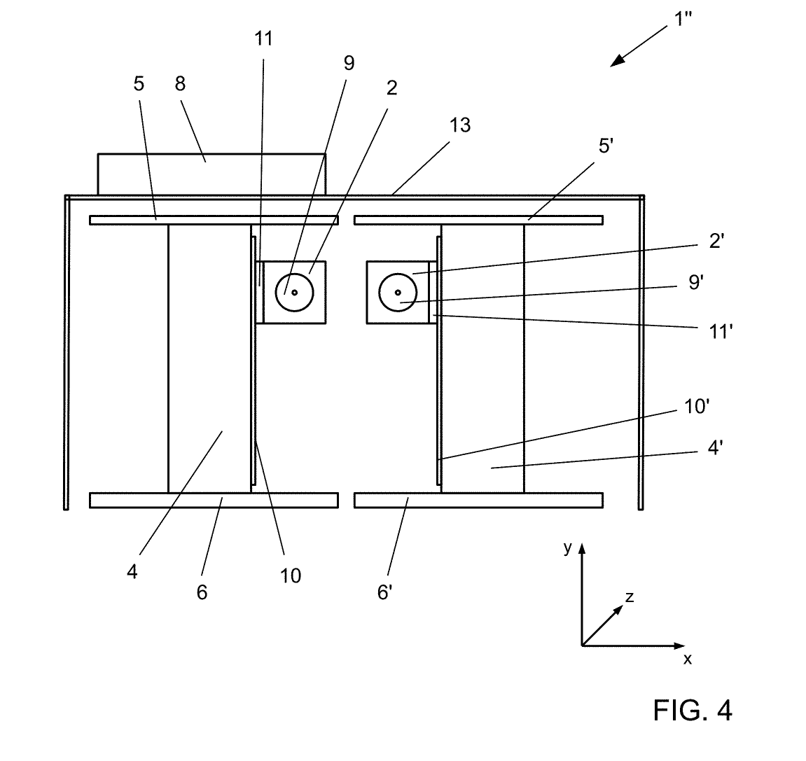

FIG. 4 schematically shows yet another embodiment of a machine tool according to the invention in a frontal view.

FIG. 1 schematically shows a possible embodiment of a machine tool 1 according to the invention in a frontal view.

In the shown embodiment, the machine tool 1 is a tooling machine with at least two machining units 2, 2′ in form of spindles.

The machine tool 1 shown in FIG. 1 comprises a machine bed 3 on which two stand units 4, 4′ are provided. The stand units 4, 4′ are each guided by a horizontal lower guide 6, 6′ provided on the machine bed 3 and by a horizontal upper guide 5, 5′ along a first axial direction x. The shown stand units 4, 4′ are movable independently from each other and can thus be moved towards, against and with each other. Such a movability of the stand units 4, 4′ provides a high flexibility of the machine tool 1 as well as a high production accuracy. The movability of the stand units 4, 4′, not only enables it to provide additional or alternative machining units 2, 2′ in exchange for or in addition to the machining units 2, 2′ already provided on the machine tool 1, and to process a multitude of different workpieces, but also serves for carrying out corrections on the processes during a processing procedure, in order to be able to avoid or compensate for problems from preceding procedures in subsequent processing procedures.

In further embodiments of the machine tool 1, the stand units 4, 4′ can, however, also be coupled, for example in order to keep down the costs and the effort of programming and/or operating the machine tool 1. Thereby, the stand units 4, 4′ can be decouplable again, since the flexibility of the machine tool is thus not unnecessarily limited.

In the embodiment of the machine tool 1 shown in FIG. 1, the machining units 2, 2′ are attached to the stand units 4, 4′. The machining units 2, 2′ are movable on horizontal guides 11, 11′, which are provided in form of slides provided on vertical guides 10, 10′ attached to the stand units 4, 4′.

In the shown embodiment, the vertical guides 10, 10′ positioned on the stand units 4, 4′ are provided on sides of the stand units 4, 4′ opposing each other in the first axial direction x. The machining units 2, 2′ are movable on the vertical guides 10, 10′ along the second axial direction y.

The horizontal guides 11, 11′ enable a movement of the machining units 2, 2′ towards the third axial direction z.

A movement of the machining units 2, 2′ along the first axial direction x is enabled by a guided movement of the stand units 4, 4′ along the guides 5, 5′, 6, 6′. The movement of the stand units 4, 4′ is preferably realized by means of linear motors 7, 7′, can, however, also be enabled by a screw drive or another drive. Furthermore, the drive 7, 7′ does not have to be attached to the ends of the guides 6, 6′ as in the embodiment illustrated in FIG. 1, but can be placed on any other position of the machine tool 1 or outside the machine tool 1. The dimensioning of the drives 7, 7′ is also variable and can be adjusted to the operating conditions of the drive 7, 7′. As described above, one drive 7, 7′ can moreover also serve as a drive for several machining units 2, 2′ and/or for a movement in several axial directions.

Just like the stand units 4, 4′, the horizontal guides 11, 11′ and the machining units 2, 2′ are also movable by drives, not depicted here. The drives used for this purpose are also largely variable with regard to their dimensioning and arrangement on the machine tool 1. As described above, it is furthermore also possible for several components of the machine tool 1 to be driven by a common drive.

The working width B of the machine tool 1 is determined by the distance between the stand units 4, 4′. By moving the stand units 4, 4′ away from each other, the working width B of the machine tool 1 can be extended, and by moving the stand units 4, 4′ towards each other, the working width B of the machine tool 1 can be reduced. The maximum operating width B is limited by the length of the upper and lower guides 5, 5′, 6, 6′, wherein the operating width B can be extended by attaching further guiding elements on the ends of the upper and lower guides 5, 5′, 6, 6′. Hereby, it is particularly preferable if the drive 7, 7′ is flexible in such a way that its position can be easily changed. In addition, there is, however, also the possibility to replace the drive 7, 7′ with a new drive when prolonging the guides 5, 5′, 6, 6′.

As described above, moving the stand units 4, 4′ and thus varying the working width B, makes it possible to ideally process workpieces with different dimensions on the machine tool 1 and to be able to provide at least one additional machining unit 2″ on the machine tool 1, whereby the output quantity of the machine tool 1 can be increased. The at least one additional machining unit 2″ can for example be provided between the or also adjacent to one of the machining units 2, 2′ and/or can be coupled mechanically with them or it. The additional machining unit 2″ can be coupled with one or both adjacent machining units 2, 2′ or can be provided entirely mechanically separate from the movement of the at least two machining units 2, 2′ already existing on the machine tool 1.

In the embodiment illustrated in FIG. 1, the machining units 2, 2′ comprise the same structure, can, however, also comprise different structures in alternative embodiments. Furthermore, the machining units 2, 2′ also comprise the same travel paths in the example of FIG. 1, but can also have different travel paths.

The machine tool 1 shown in FIG. 1 comprises a casing enclosing it, which is not depicted for reasons of clarity.

FIG. 2 schematically shows the machine tool 1 of FIG. 1 in a frontal view diagonally from above. Thereby, the same reference signs as in FIG. 1 correspond to the same components, which is why it is being referred to the preceding description of these components.

In FIG. 2, the casing of the machine tool 1 is also not depicted for reasons of a better illustration of the machine tool 1 according to the invention.

In FIG. 2, the movability of the machining units 2, 2′ by means of the horizontal guides 11, 11′ in the third axial direction z is illustrated. The movement of the machining units 2, 2′ in the second axial direction y along the vertical guides 10, 10′ is also discernible from FIG. 2.

In the shown embodiment, the guides 6, 6′, 10, 10′, 11, 11′ each comprise two guiding rails, can, however, also comprise only one guiding rail, as exemplified by the guides 5, 5′. In general, all guides 5, 5′, 6, 6′, 10, 10′, 11, 11′ used on the machine tool 1, can be formed as desired and comprise any desired lengths. When determining the lengths of the guides 5, 5′, 6, 6′, it is only to be noted that the maximum working width B of the machine tool 1 is generally determined by the lengths of the guides 5, 5′, 6, 6′ and the distance between the guides 5, 5′, 6, 6′.

In contrast to FIG. 2, the machine tool 1 can also comprise a common upper and/or lower guide 5″, 6″ for the stand units 4, 4′ and no separate guides 5, 5′ and 6, 6′ in another embodiment of the present invention not depicted here.

In FIG. 3a, another embodiment of the machine tool 1′ according to the invention is schematically shown in a frontal view, wherein the same reference signs correspond to the same components as in FIGS. 1 and 2. Reference is hereby made to the above mentioned embodiments of these components.

In the embodiment illustrated in FIG. 3a, the stand units 4, 4′ are only guided through a lower guide 6″ and no upper guides 5, 5′. In contrast to the variants of the machine tool 1 illustrated above, the stand units 4, 4′ are also guided on a common guide 6″ and not by two separate guides 6, 6′ in FIG. 3a.

The stand units 4, 4′ of the machine tool 1′ depicted in FIG. 3a, are connected by means of a bridge 12, whereby the machining units 2, 2′ can only be moved together in the first axial direction x. However, in the second axial direction y and the third axial direction z, the machining units 2, 2′ can also be moved independently from each other in the machine tool 1′. However, it is also possible to couple the movement of the machining units in the second axial direction y and in the third axial direction by means of mechanical coupling devices, not depicted here.

Furthermore, the machine tool 1′ can be formed in such a way, that the stand units 4, 4′ are guided completely separate from each other through at least one lower guide 6, 6′, 6″ without the stand units 4, 4′ comprising an upper guide 5, 5′ or a bridge 12, through which the stand units 4, 4′ are connected to each other. Notwithstanding the lack of the at least one upper guide 5, 5′, the stand units 4, 4′ are movable independently from each other in the first axial direction x with such an embodiment of the machine unit 1′.

In contrast to the embodiments of the machine tool 1, in which the stand units 4, 4′ are movable, the working width B of the machine tool 1′ depicted in FIG. 3a, is not variable. However, the working width B of the machine tool illustrated in FIG. 3a is formed so large that at least one additional machining unit 2″ can be provided between the two machining units 2, 2′. Hereby, the additionally provided machining unit 2″ preferably comprises the same travel path and/or the same structure as the two already existing machining units 2, 2′ of the machine tool 1′.

Due to the connection of the stand units 4, 4′ by means of the bridge 12, the machine tool 1′ from FIG. 3a comprises a particularly high mechanical load capacity.

FIG. 3b schematically shows the machine tool 1′ depicted in FIG. 3a with an additional machining unit 2″ in a frontal view. Hereby, reference signs already used above refer to the same components, to whose preceding description is hereby referred.

In the shown embodiment, the machining unit 2″ additionally provided between the machining units 2, 2′, is mechanically coupled with the machining units 2, 2′, so that all three machining units 2, 2′, 2″ perform the same movements, at least in the first axial direction x and the second axial direction y.

However, in other, not depicted embodiments of the present invention, the additional machining unit 2″ can also be coupled with only one of the two machining units 2, 2′ and/or be spaced apart from at least one of the two machining units 2, 2′. Thus, not all machining units 2, 2′, 2″ have to perform the same movements; only the additionally included machining unit 2″ and at least one machining unit 2 or 2′ coupled thereto, herein perform the same movements. With such an embodiment, the machining unit 2 or 2′ not coupled with the additional machining unit 2″, is in contrast movable independently from the other two machining units 2 or 2′ and 2″.

In contrast to the embodiment of the machine tool 1′ depicted in FIGS. 3a and 3b, the working width B of the machine tool can be formed so large that more than one additional machining unit 2″ can be provided between the two machining units 2, 2′. Hereby, it can be freely chosen, which machining units and movement directions are coupled. However, it is particularly recommendable to form couplings between the machining units of such a machine tool according to the invention to be detachable again.

FIG. 4 schematically shows a further embodiment of a machine tool 1″ according to the invention in a frontal view, wherein here also the already used reference signs refer to the same components of the machine tool 1″ as in the above described figures.

In FIG. 4, a casing 13 of the machine tool 1″ is schematically depicted, wherein a control cabinet 8 is provided on the roof surface of the casing 13 pointing upwards. By arranging the control cabinet 8 on the roof of the machine tool 1″, the machine tool 1″ is freely accessible for its operator, whereby possible sources of error, maintenance or repair works can be carried out quickly and easily on the machine tool 1″. Furthermore, providing the control cabinet 8 on the machine tool 1″ offers the advantage that the space requirements of the entire machine tool 1″ can be minimized and thus the total costs can be reduced.

In contrast to the embodiment shown in FIG. 4, the control cabinet 8 can also be provided in an upper area of a side wall of the casing 13 of the machine tool 1″. This offers the advantage that the machine tool 1″ remains accessible for its operator, just as well as when the control cabinet 8 is placed on the roof of the machine tool 1″, and the control cabinet 8 is, in spite of everything, accessible for the operator of the machine tool 1″.

At its simplest, the control cabinet 8 is connected to the casing 13 by means of screw or rivet connections. However, an additional device for holding the control cabinet 8 can also be provided on the casing 13 of the machine tool 1″. For a possible assembly and/or disassembly of the machine tool 1″, it is, however, useful to detachably connect the control cabinet 8 with the casing 13 of the machine tool 1″.

If the machine tool 1″ comprises several control cabinets 8, it is furthermore also possible to attach several control cabinets 8 spread on the roof and/or on the upper areas of the side walls of the machine tool 1″. Correspondingly, the arrangement of the at least one control cabinet 8 can be chosen depending on the location of the machine tool 1″.

FIG. 4 only shows an embodiment of a machine tool 1″ according to the invention on whose casing 13, especially on its roof, a control cabinet 8 is provided. In other embodiments, the interior of the casing 13 of the machine tool 1″ can, as described in the previous embodiments, also be formed differently. Contrary to the depiction in FIG. 4, the machine tool 1″ can thus for example comprise continuous guides 5″, 6″ and no separate guides 5, 5′, 6, 6′. Furthermore, a different number of machining units 2, 2′ can also be provided in the machine tool 1″. The stand units 4, 4′ can also only be guided below or can, if necessary, be connected by means of a bridge.

1-6. (canceled)

7. A machine tool, comprising:
a machine bed;
at least one first and one second machining unit being disposed adjacent each other in a first axial direction, being movable independently of each other in first, second and third axial directions and being disposed together above said machine bed;
stand units being spaced apart in said first axial direction and disposed on both sides of said machining units, said stand units having upwardly facing and downwardly facing sides;
upper and lower guides disposed on said upwardly facing and downwardly facing sides of said stand units for guiding said machining units; and
at least one additional guiding element configured to be attached for extending said guides to increase a distance between at least two of said machining units.

8. The machine tool according to claim 7, wherein said stand units are movably guided on said upper and lower guides.

9. The machine tool according to claim 7, wherein at least two of said machining units are coupled or configured to be coupled and decoupled in at least one of said first, second or third axial directions.

10. The machine tool according to claim 7, wherein at least one of said machining units is configured to perform a swivel movement around at least one of said first or second axial directions.

11. The machine tool according to claim 10, wherein at least two of said machining units are coupled or configured to be coupled and decoupled in said swivel movement around at least one of said first or second axial directions.

12. The machine tool according to claim 7, which further comprises at least one control cabinet disposed in an upper half of the machine tool.

13. A machine tool, comprising:
a machine bed;
at least one first and one second machining unit being disposed adjacent each other in a first axial direction, being movable independently of each other in second and third axial directions and being disposed together above said machine bed;
stand units disposed on both sides of said machining units, and said stand units being spaced apart in said first axial direction by a distance defining a fixed working width;
at least one third machining unit configured to be provided and removed again in said first axial direction adjacent at least one of said first second machining units due to said working width;
all of said machining units being at least one of structurally identical or having identical travel paths; and
a bridge interconnecting said stand units and permitting said machining units to only be jointly movable in said first axial direction.

14. The machine tool according to claim 13, wherein said stand units are movably guided on said upper and lower guides.

15. The machine tool according to claim 13, wherein at least two of said machining units are coupled or configured to be coupled and decoupled in at least one of said first, second or third axial directions.

16. The machine tool according to claim 13, wherein at least one of said machining units is configured to perform a swivel movement around at least one of said first or second axial directions.

17. The machine tool according to claim 16, wherein at least two of said machining units are coupled or configured to be coupled and decoupled in said swivel movement around at least one of said first or second axial directions.

18. The machine tool according to claim 13, which further comprises at least one control cabinet disposed in an upper half of the machine tool.
